(19) United States
(12) Patent Application Publication
(10) Pub. No.: US 2006/0230426 A1
(43) Pub. Date: Oct. 12, 2006

(54) Multimedia and audio-visual device

(76) Inventor: Sheng-Fu Lu, Tashi Town (TW)

Correspondence Address: TROXELL LAW OFFICE PLLC;Suite 1404, 5205 Leesburg Pike, Falls Church, VA, 22041, US

(21) Appl. No.: 11/149,251

(22) Filed: Jun. 10, 2005

(30) Foreign Application Priority Data
Apr. 12, 2005 (TW) 94205661

(51) Int. Cl. H04N 7/173; H04N 7/16; H04N 7/18

(52) U.S. Cl. 725/131; 725/100; 725/140; 725/139; 725/81

(57) ABSTRACT

A multimedia and audio-visual device is provided with the functions of working as a GPS, and showing MP3 music, digital pictures, and digital television programs. The multimedia and audio-visual device comprises: a main body, a liftable monitor, a power-sourcing device, and a desktop charger. The main body is a rectangular, flat casing. The liftable monitor is connected to the main body through a pivot to enable the liftable monitor to be watched from various angles. When folded, the liftable monitor is located to touch a recessed portion of the main body. Several operation keys are mounted on the main body below the liftable monitor for controlling the working of the main body. When the main body is coupled with the desktop charger having the built-in digital television module, the main body becomes a television for receiving the digital television signal. Besides, the desktop charger can charge the power-sourcing device simultaneously.

### FIELD OF THE INVENTION

The present invention relates to a portable, multimedia, and audio-visual device, which is provided with the functions of showing television programs, working as a GPS (Global Positioning System), a MP3 player, and a Gameboy, and showing pictures. When a power-sourcing device is applied, the multimedia and audio-visual device can be carried and used in car.

### BACKGROUND OF THE INVENTION

With progress in technology, a variety of multimedia and audio-visual devices are disclosed. In point of the visual device, the early videocassette recorder is gradually replaced by the VCD player, even by the DVD player that provides better image quality. Besides, in point of the audio device, the CD player and the MP3 player have replaced the tape recorder.

However, a single existing audio-visual device is only provided with a single function. For example, the PDA (Personal Digital Assistant) can be operated as an audio-visual device, but it cannot be applied to watch the wireless television programs. In absence of a receiving box, the car TV cannot be applied to watch the television programs. However, the receiving box has big size and is not suitable for outdoor use. Accordingly, it is a challenge to integrate the multimedia and audio-visual device and give consideration to the convenience in personal carry.

### SUMMARY OF THE INVENTION

It is a main object of the present invention to provide a multimedia and audio-visual device, which is provided with the functions of showing television programs, working as a GPS, a MP3 player, and a Gameboy, and showing pictures. When a power-sourcing device is applied, the multimedia and audio-visual device can be carried and used in car.

It is another object of the present invention to provide a multimedia and audio-visual device in which the liftable monitor is connected to the main body through a pivot to enable the liftable monitor to be watched from various angles.

It is still another object of the present invention to provide a multimedia and audio-visual device. When the main body is coupled with the desktop charger having the built-in digital television module, the multimedia and audio-visual device becomes a television for receiving the digital television signal. Besides, the desktop charger can charge the power-sourcing device simultaneously.

Other objects and features of the present invention will become apparent from the following detailed description when taken in conjunction with the drawings in which:

### BRIEF DESCRIPTION OF THE DRAWINGS

FIG. 1 is an elevational view of the present invention.

FIG. 2 is a schematic, exploded view showing the power-sourcing device and the main body of the present invention.

FIG. 3 is a schematic view showing that the memory card is inserted into the main body of the present invention.

FIG. 4 is a schematic view showing that the main body is coupled with the desktop charger of the present invention.

FIG. 5 is a schematic, exploded view of the structure shown in FIG. 4.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

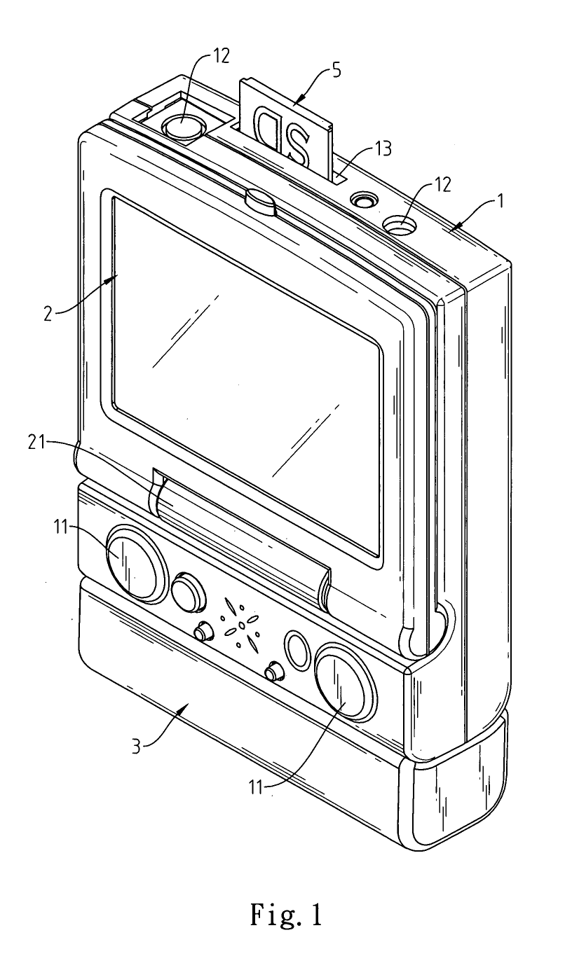

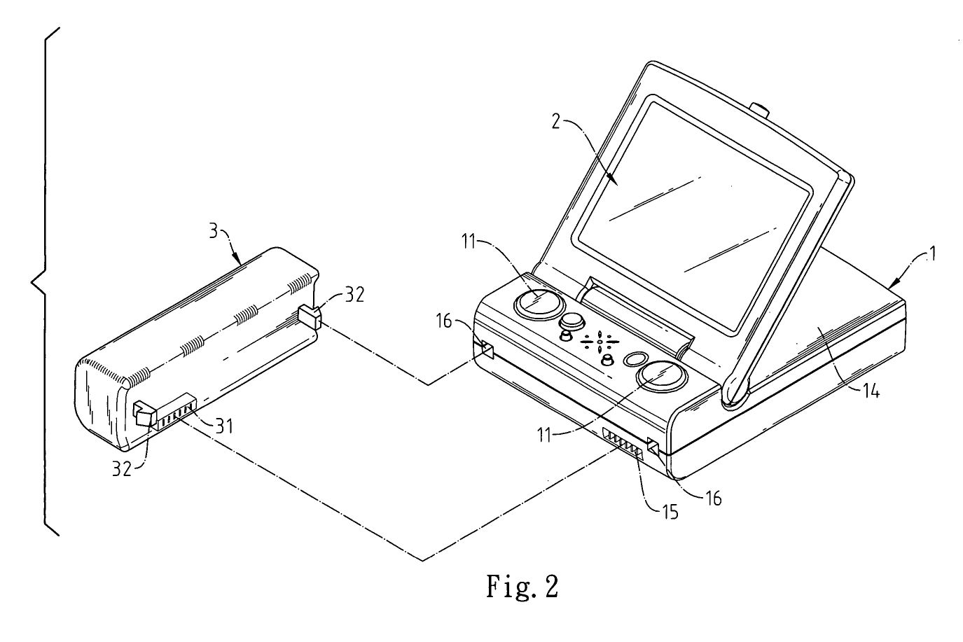

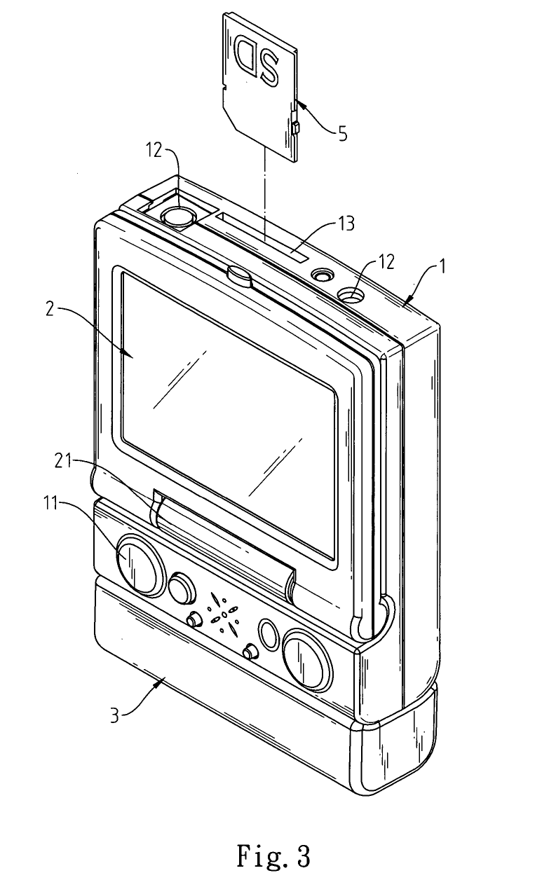

Referring to FIG. 1 through FIG. 4, a multimedia and audio-visual device of the present invention comprises a main body 1, a liftable monitor 2, a power-sourcing device 3, and a desktop charger 4. The main body 1 is a rectangular, flat casing inside which a circuit board is mounted. The liftable monitor 2 is a TFT-LCD panel for showing data or pictures. The liftable monitor 2 is connected to the main body 1 through a pivot 21, wherein the pivot 21 is located between the liftable monitor 2 and the operation keys 11 to enable the liftable monitor 2 to be lifted upward in various angles relative to the main body 1, thereby facilitating the watching of the liftable monitor 2 from different angles. When folded, the liftable monitor 2 is designed to touch a recessed portion 14 of the main body 1. The operation keys 11 are mounted on the main body 1 below the liftable monitor 2 for controlling the working of the main body 1.

Several jacks 12 are mounted on the periphery of the main body 1 for being connected to, for example, a speaker by external signal lines. Besides, an insertion slot 13 is formed on the periphery of the main body 1 for insertion of a memory card 5 on which GPS (Global Positioning System) maps, MP3 music, or JPEG pictures can be stored. When the memory card 5 is inserted into the insertion slot 13 of the main body 1, the GPS can be worked, the music can be listened to, and the pictures can be shown. An electrode terminal 15 is mounted on the bottom of the main body 1 to correspond to an electrode terminal 31 of the power-sourcing device 3. The power-sourcing device 3 is a detachable rechargeable battery or a general dry battery. The power-sourcing device 3 is mounted on one side of the main body 1 for supplying the electric power for the main body 1. A detent 32 of the power-sourcing device 3 is inserted into an insertion hole 16 of the main body 1 for providing the electric power through the electrode terminal 15 and the electrode terminal 31.

The desktop charger 4 is a bracket, and a digital television module 45 is built-in the desktop charger 4. Accordingly, when the main body 1 is coupled with the desktop charger 4, the multimedia and audio-visual device of the present invention becomes a television for receiving the digital television signal. A charging socket 41 is formed on the desktop charger 4 for holding the main body 1, and a charging socket 42 is formed on the desktop charger 4 for holding the power-sourcing device 3. An electrode terminal 41′ and an electrode terminal 42′ are mounted in the charging sockets 41 and 42, respectively. An antenna 43 is mounted on a corner of the desktop charger 4 for receiving the wireless signal. At least a speaker 44 is mounted on the desktop charger 4 to enable the main body 1 to output the voice.

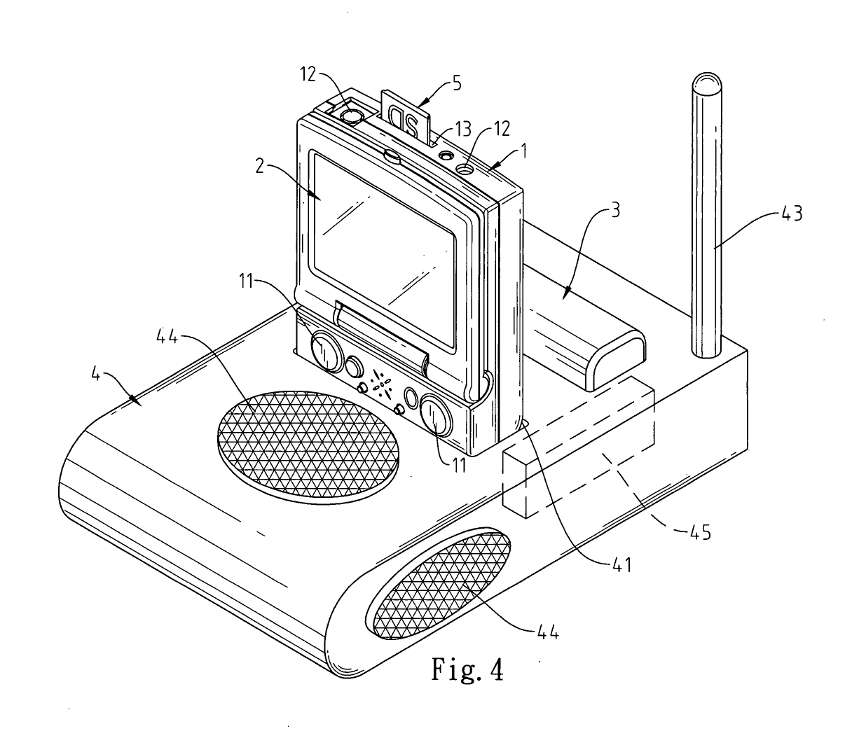

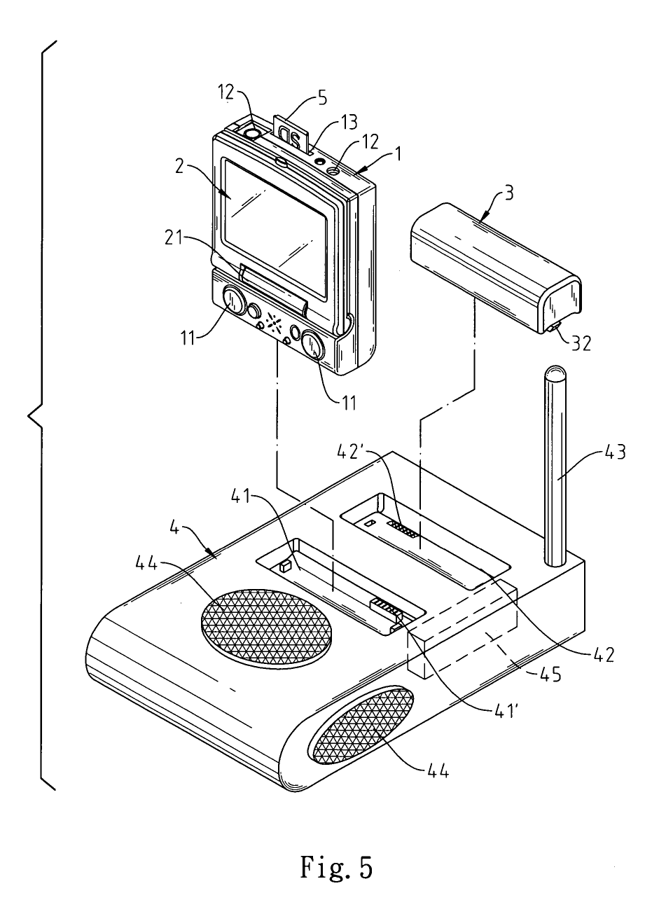

Referring to FIG. 4 and FIG. 5, the main body 1 can display the MP3 music and show the JPEG pictures by reading the memory card 5. Furthermore, by use of the memory card 5 on which the digital maps are stored, the multimedia and audio-visual device can be operated as a GPS. Because the liftable monitor 2 can be lifted up, the liftable monitor 2 can be adjusted to provide a best view angle through the pivot 21. The main body 1 is powered by the power-sourcing device 3. When the electric power of the power-sourcing device 3 is exhausted, the power-sourcing device 3 can be detached and recharged through the desktop charger 4. In absence of the power-sourcing device 3, the main body 1 is powered by the desktop charger 4 directly. Besides, the television program can be watched by inserting the main body 1 into the desktop charger 4 having the built-in digital television module 45.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A multimedia and audio-visual device, comprising:
a main body, the main body being a casing inside which a circuit board is mounted, the main body comprising: a plurality of operation keys on a surface of the main body; a plurality of jacks on the periphery of the main body for insertion of a plurality of signal lines; and an insertion slot on the periphery of the main body for insertion of a memory card;
a liftable monitor connected to the main body through a pivot, the pivot being located between the liftable monitor and the operation keys to enable the liftable monitor to be lifted in various angles relative to the main body;
a power-sourcing device for providing electric power for the main body by inserting a detent of the power-sourcing device into an insertion hole of the main body; and
a desktop charger, the desktop charger being a bracket having a digital television module, the desktop charger comprising: an antenna mounted on a corner of the desktop charger; at least a speaker; and at least two charging sockets, each having an electrode terminal,
wherein when the memory card having digital maps, data, music, and pictures is inserted into the insertion slot of the main body, the main body can work as a GPS and show data, music, and pictures; and when the main body is coupled with the desktop charger having the digital television module, the main body becomes a television for receiving a digital television signal, and the desktop charger can supply the electric power for the main body and charge the power-sourcing device simultaneously.
